(19) United States
(12) Patent Application Publication
(10) Pub. No.: US 2014/0271995 A1
(43) Pub. Date: Sep. 18, 2014

(54) DRINKING WATER COMPOSITION AND METHOD OF PRODUCTION

(71) Applicant: BEVERLY HILLS DRINK COMPANY, INC., Beverly Hills, CA (US)

(72) Inventors: Jon Gluck, Beverly Hills, CA (US); Adrian Gluck, Beverly Hills, CA (US); Martin Riese, Los Angeles, CA (US)

(73) Assignee: Beverly Hills Drink Company, Inc., Beverly Hills, CA (US)

(21) Appl. No.: 13/836,343

(22) Filed: Mar. 15, 2013

(51) Int. Cl. C02F 1/68

(52) U.S. Cl. CPC C02F 1/68
USPC 426/66

(57) ABSTRACT

A composition for drinking water and a method for preparing the same are presented. The composition includes a volume of water and a predetermined amount of each of calcium, magnesium, potassium, and silica. The method includes obtaining the volume of water, testing the volume of water to determine the amount of these four minerals in the volume, and adding a mineral packet to the volume of water, wherein the mineral packet includes predetermined amounts of these four minerals.

### BACKGROUND

1. Field

The presently disclosed embodiments relate generally to a drinking water composition, and more specifically to a water composition containing controlled amounts of minerals such as calcium, magnesium, potassium and silica.

2. Description of the Related Art

There is a large industry surrounding bottled water, generally based on the improved taste and health benefits over tap water. Currently, the industry usually uses one of two methods to generate bottled water. In the first method, water is extracted from a natural source, such as a spring. The water is taken from that natural source, bottled, and delivered to the consumer in an “as-is” state, directly from the natural source.

In the second method, water is taken from a municipal tap source and filtered to remove undesirable chemicals, biological contaminants and other impurities. The water is then bottled and delivered to the consumer.

There are a number of disadvantages with the current methods. They do not enable enhancement of the water to improve its taste. The natural source extraction method is generally dependent on a single source with a lack of a secondary back-up source, allowing for a limited available quantity of water, and the risk of total loss of business in case of source contamination. The seasonal fluctuations in mineral content at these single sources can cause inconsistency in taste, which is undesirable from a consumer marketing point of view.

In addition to plain drinking water, consumers may purchase “enhanced” (also known as “functional”) waters, which are bottled waters that have added flavors and/or nutrients, such as vitamins, electrolytes, and amino acids. The Food and Drug Administration requires that such enhanced water be specifically labeled to identify all flavorings and nutrients added on the label, because they are not natural water. This, combined with the fact that the taste of this water does not resemble that of natural water, combines to not make it desirable to consumers seeking the taste of fresh, natural water.

It would therefore be advantageous to offer a water formulation that improves on previously available water formulations to make a natural water that has a much improved taste.

### SUMMARY

According to an embodiment, provided is a composition for drinking water, comprising a volume of water and a predetermined amount of each of a set of minerals including calcium, magnesium, potassium, and silica. In one embodiment, the amount of calcium is between about 33 and about 41 mg per liter of the composition, the amount of magnesium is between about 47 and about 58 mg per liter of the composition, the amount of potassium is between about 61 and about 74 mg per liter of the composition, and the amount of silica is between about 57 and about 71 mg per liter of the composition, and the composition is preferably alkaline with a pH level of about 7.5.

Also provided is a method for preparing a drinking water composition, comprising obtaining a volume of water, testing the volume of water to determine the amount of calcium, magnesium, potassium, and silica in the volume, adding a mineral packet to the volume of water, wherein the mineral packet includes predetermined amounts of calcium, magnesium, potassium, and silica, based on the tested amounts of the minerals, to create the drinking water composition.

The mineral packet may include between about 33 and about 41 mg of calcium per liter of the drinking water composition, between about 47 and about 58 mg of magnesium per liter of the drinking water composition, between about 61 and about 74 mg of potassium per liter of the drinking water composition, and between about 57 and about 71 mg of silica per liter of the drinking water composition. In another embodiment, the mineral packet may include about 37 mg of calcium per liter of the drinking water composition, about 52.8 mg of magnesium per liter of the drinking water composition, about 67.3 mg of potassium per liter of the drinking water composition, and about 64 mg of silica per liter of the drinking water composition.

### BRIEF DESCRIPTION OF THE FIGURES

For a more complete understanding of the present disclosure, reference is now made to the following FIGURE:

FIG. 1 illustrates a method of preparing a drinking water composition according to current embodiments.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

The present embodiments are directed to a composition of drinking water and a method for preparing such a composition. The embodiments create much better tasting and more refreshing water than what is currently available. The water is treated in a way that allows for the water to avoid becoming classified by the Food and Drug Administration as “enhanced” or “functional” bottled water. The water composition according to present embodiments may be promoted and sold as “natural” or “pure,” thus increasing consumer demand and avoiding additional labeling that may be required by the Food and Drug Administration.

The current embodiments allow for a water composition with a mineral content that achieves a unique character that remains consistent with the consumer expectation of a natural water. The water composition has a light mineral taste, a smooth feel in the mouth, a refreshing taste, a clean finish, and it makes for a good pairing with wine and food.

FIG. 1 shows one method of preparing a water composition according to present embodiments. In step 101, a volume of water is obtained from a natural source. The natural source may be a natural spring, well water, artesian water, municipal water, any other source that has levels of minerals lower than the desired levels, and even distilled water. In preferred embodiments, the natural source has an ample supply of water and relatively consistent mineral levels throughout the year. In further preferred embodiments, the natural source is close to the plant or other location where the minerals are added and/or the water is bottled. In further preferred embodiments, the natural source is selected such that no chemicals must be used to treat the water, storage tanks, or any of the water system components.

In step 102, the volume of water is tested for selected mineral content. This step is not necessary if the volume of water has a known, stable range of minerals. In additional embodiments, the mineral content of a water source may be tested from time to time, separate from the particular volume of water to which the mineral packets will be added. The mineral packet compositions could be based upon this occasional testing instead of on each volume of water.

In step 103, mineral packets are obtained or prepared based on the tested mineral content, in accordance with standard manufacturing procedures known in the art of prepackaged mineral ingredients. In certain embodiments, the mineral content from the tested volume of water is used to create one or more mineral packets that, when added to the volume of water, will create the desired total mass concentration of each mineral. In alternate embodiments, the mineral packets are created based on an average or previously tested mineral content of the natural source water.

In embodiments, the mineral packets are prepared by mixing each of a set of mineral compounds together to form a mixture of minerals. The mineral compounds that may be used are discussed further below. The mineral compounds may be obtained in various forms that allow the minerals to be dissolved into the volume of water. The mineral compounds may be mixed in a pre-ground or granular form or may be ground after mixing and may be provided in liquid form. If the mineral compounds are pre-ground, they may be further ground to make a finer powder mixture. In still further embodiments, the mineral compounds may be added individually or a few at a time in any viable form until the desired levels of mineral compounds are added.

The mineral packets are created by mixing mineral compounds that will provide the desired minerals to the volume of water. The mineral compounds added are calcium chloride (to provide calcium), magnesium chloride (to provide magnesium), potassium bicarbonate (to provide potassium), and silicon dioxide (to provide silica). These mineral compounds provide the optimum taste profile for the present embodiments. Other potential mineral compounds could include, but are not limited to, calcium phosphate, calcium lactate, calcium citrate, magnesium citrate, magnesium lactate, magnesium oxide, potassium citrate, and potassium chloride, as long as they are selected in amounts that create a light mineral taste, a smooth feel in the mouth, a refreshing taste, and a clean finish.

The mineral packets may contain one or more mineral compounds, such that one or more mineral packets may be used to provide the desired minerals to the volume of water. For example, if the mineral compounds are calcium chloride, magnesium chloride, potassium bicarbonate, and silicon dioxide, there may be one packet for each volume of water containing all four compounds. Alternatively, there may be one packet containing potassium bicarbonate and silicon dioxide and another containing calcium chloride and magnesium chloride. In still alternative embodiments, there may be one of each of the compounds in four separate packets, or different combinations of three, two, and/or one compound in a set of packets.

The mineral packets may be made based on one or more volumes of water. Although they are called “packets” herein, the word “packet” is in no way intended to limit the container of the mineral packets. Containers could be, without limitation, dishes, beakers, boxes, flat packets made of paper, lined or not, or other flexible material, test tubes, bottles, and bowls.

In step 104, the mineral packets are added to the volume of water to obtain desired mineral content in the volume. The addition may be in a large batch, for example, or in smaller batches. The mineral packets may be mixed, such as by stirring or shaking, into the volume of water. The volume of water may be further tested after addition of the mineral packets to ensure that the mineral content of the final water composition is within the desired range.

Finally, in step 105, the water may be bottled with the added mineral packets already mixed in. The bottles may be individual sized or larger, such as five gallon water bottles, depending on the quantity of water desired and the desired means of dispensing. Prior to the capping of the bottles, the water may be subjected to ozonation, UV, or other methods, which destroy bacteria and other microorganisms, and may also extend shelf-life. Once bottled, the bottled water may be shipped and/or sold to merchants and consumers. In other embodiments, the water may be delivered and used as facial spray, as bathing water, and as ingredients in foods, beverages, and topical medications including creams, foams, gels, lotions and ointments.

The mineral content of the preferred embodiment shown in Table 1 achieves the unique characteristics described herein. The amounts of minerals are given in mass concentrations of milligrams constituent per liter of solution. The source mineral amounts are based upon the amounts tested in a volume of water from the natural springs in Baxter, Calif. in October 2011. The natural springs at Baxter, Calif., located at the 4,000-foot level in the Sierra Nevada Mountains, have been a natural resource beneficially used since the days of the early settlers in the latter part of the 19^{th} century. These springs flow year round and are fed by the snowmelt from higher elevations. The 1000 acres of forestland at Baxter, on which the natural springs are located, are a zoned timberland preserve, which restricts commercial development and preserves the natural ecology. In embodiments, the source mineral amounts would vary depending on source and timing. The values in Table 1 under the heading “Added Amount of Mineral” include only the portion of the mineral compound attributable to the desired mineral (e.g., calcium, magnesium, etc.) and do not include any other components in the mineral compound that would also be added. Thus, the “30 mg/L” in the first row is of calcium only, not of calcium chloride as a whole. The values under the heading “Total Amount of Mineral” indicate the total mass concentration of each mineral in the particular embodiment created through the addition of the added mineral compound to the water source shown in the table as well as a desired range of total mineral mass concentrations that achieve the characteristics described herein.

TABLE 1

| | | Source | Added | |
|---|---|---|---|---|
| | | Amount of | Amount of | Total Amount |
| Source | Added Mineral | Mineral | Mineral | of Mineral |
| Mineral | Compound | (mg/L) | (mg/L) | (mg/L) |
| Calcium | Calcium Chloride | 7 | 30 | 37 ± 10% |
| Magnesium | Magnesium | 2.8 | 50 | 52.8 ± 10% |
| | Chloride | | | |
| Potassium | Potassium | 2.3 | 65 | 67.3 ± 10% |
| | Bicarbonate | | | |
| Silica | Silicon Dioxide | 54 | 10 | 64 ± 10% |

According to embodiments, the range of the mass concentration of calcium in the volume of water, after adding the mineral packets, is 37±10% mg/L, or between about 33.3 and about 40.7 mg/L, the range of the mass concentration of magnesium in the volume of water, after adding the mineral packets, is 52.8±10% mg/L, or between about 47.5 and about 58.1 mg/L., the range of the mass concentration of potassium in the volume of water, after adding the mineral packets, is 67.3±10% mg/L, or between about 60.6 and about 74.0 mg/L., the range of the mass concentration of silica in the volume of water, after adding the mineral packets, is 64±10% mg/L, or between about 57.6 and about 70.4 mg/L. In particular embodiments, the mass concentrations of minerals in the volume of water, after adding the mineral packets, is about 37 mg/L calcium, about 52.8 mg/L magnesium, about 67.3 mg/L potassium, and about 65 mg/L silica. While the ranges in the formulation may be plus or minus ten percent from those disclosed, other ranges such as plus or minus five percent may be employed depending on circumstances and desired water profile. In further embodiments, the mass concentrations of minerals are lower than those listed above.

In embodiments, two mineral packets are used for one liter of water. The first contains calcium chloride and magnesium chloride, where the masses of each component are about 30 mg of calcium (from calcium chloride), about 58 mg of chloride (from calcium chloride), about 50 mg of magnesium (from magnesium chloride, anhydrous) and about 146 mg of chloride (from magnesium chloride, anhydrous). The second packet contains potassium bicarbonate and silicon dioxide, where the masses of each component are about 65 mg of potassium (from potassium bicarbonate), 101 mg of bicarbonate (from potassium bicarbonate), about 4.675 mg of silicon (from silicon dioxide), and about 5.325 mg of dioxide (from silicon dioxide). These mineral packets contain mass concentrations that, when added to the source water described in Table 1, provide the desired concentrations of each mineral. The packets further allow for some known variance of source water mineral values, such that the total concentration of each mineral will remain within the desired range.

It is possible to include additional minerals, added through the mineral packets or found in the natural source volume of water, such as, but not limited to, zinc, iron, sodium, nitrates, sulphates, fluoride and bicarbonates.

In embodiments, the water composition, after addition of the mineral packets, is alkaline, having a pH of greater than 7. In further embodiments, the water composition pH is about 7.5, and in other embodiments the pH is slightly acidic having a pH of about 6.5.

In further embodiments, the total dissolved solids are between 350 and 450 ppm, more particularly about 390 ppm.

By ensuring the mineral levels of the water composition as discussed herein, the water composition is able to have a fresh, refreshing taste that is smooth, silky, crisp, and light. The water also tastes natural.

While primarily described herein with respect to an exemplary bottled water manufacturing process and method for making same, the invention and disclosure herein are not intended to be so limited. Note that while certain examples are provided herein, these examples are meant to be illustrative and not limiting as to the functionality of the present system and method. Other examples and implementations are possible and this document should not be limited by the examples presented.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A composition for drinking water, comprising:
a volume of water; and
a predetermined amount of each of a set of minerals including calcium, magnesium, potassium, and silica.

2. The composition of claim 1, wherein the amount of calcium is between about 33.3 and about 40.7 mg per liter of the composition.

3. The composition of claim 1, wherein the amount of magnesium is between about 47.5 and about 58.1 mg per liter of the composition.

4. The composition of claim 1, wherein the amount of potassium is between about 60.6 and about 74.0 mg per liter of the composition.

5. The composition of claim 1, wherein the amount of silica is between about 57.6 and about 70.4 mg per liter of the composition.

6. The composition of claim 1, wherein the composition has a pH level of about 7.5.

7. The composition of claim 1, wherein the set of minerals includes:
between about 33.3 and about 40.7 mg of calcium per liter of the composition;
between about 47.5 and about 58.1 mg of magnesium per liter of the composition;
between about 60.6 and about 74.0 mg of potassium per liter of the composition; and
between about 57.6 and about 70.4 mg of silica per liter of the composition.

8. The composition of claim 1, wherein the predetermined set of minerals are composed in a set of mineral compounds including calcium chloride, magnesium chloride, potassium bicarbonate and silicon dioxide.

9. A method for preparing a drinking water composition, comprising:
obtaining a volume of water;
testing the volume of water to determine the amount of calcium, magnesium, potassium, and silica in the volume;
adding a mineral packet to the volume of water, wherein the mineral packet includes predetermined amounts of calcium, magnesium, potassium, and silica, to create the drinking water composition.

10. The method of claim 9, wherein the method further includes preparing the mineral packet based on the tested amounts of the one or more minerals.

11. The method of claim 9, wherein the one or more minerals includes calcium, magnesium, potassium, and silica.

12. The method of claim 11, wherein the mineral packet includes between about 33.3 and about 40.7 mg of calcium per liter of the drinking water composition.

13. The method of claim 11, wherein the mineral packet includes between about 47.5 and about 58.1 mg of magnesium per liter of the drinking water composition.

14. The method of claim 11, wherein the mineral packet includes between about 60.6 and about 74.0 mg of potassium per liter of the drinking water composition.

15. The method of claim 11, wherein the mineral packet includes between about 57.6 and about 70.4 mg of silica per liter of the drinking water composition.

16. The method of claim 11, wherein the mineral packet includes between about 33.3 and about 40.7 mg of calcium per liter of the drinking water composition, between about 47.5 and about 58.1 mg of magnesium per liter of the drinking water composition, between about 60.6 and about 74.0 mg of potassium per liter of the drinking water composition, and between about 57.6 and about 70.4 mg of silica per liter of the drinking water composition.

17. The method of claim 9, wherein the predetermined amount of calcium is composed in calcium chloride, the predetermined amount of magnesium is composed in magnesium chloride, and the predetermined amount of potassium is composed in potassium bicarbonate.
